(19) United States
(12) Patent Application Publication
(10) Pub. No.: US 2024/0349295 A1
(43) Pub. Date: Oct. 17, 2024

(54) CONTROL INFORMATION TRANSMISSION METHOD, APPARATUS, DEVICE, AND STORAGE MEDIUM

(71) Applicant: GUANGDONG OPPO MOBILE TELECOMMUNICATIONS CORP., LTD., Dongguan (CN)

(72) Inventors: Bin LIANG, Dongguan (CN); Jing XU, Dongguan (CN); Yi ZHANG, Dongguan (CN); Yanan LIN, Dongguan (CN)

(21) Appl. No.: 18/756,445

(22) Filed: Jun. 27, 2024

Related U.S. Application Data
(63) Continuation of application No. PCT/CN2021/143575, filed on Dec. 31, 2021.

(51) Int. Cl. H04W 72/231; H04L 1/00; H04W 72/0453; H04W 72/12

(52) U.S. Cl. CPC H04W 72/231; H04L 1/0008; H04W 72/0453; H04W 72/12

(57) ABSTRACT

A control information transmission method, apparatus, device, and storage medium; a terminal device obtains configuration information, then monitors any of the at least one downlink control information format according to the configuration information; the configuration information is used for configuring an available downlink control information format of the terminal device, the available downlink control information format includes a first downlink control information format, the first downlink control information format being used for simultaneously scheduling a plurality of carriers.

### CROSS-REFERENCE TO RELATED APPLICATION

This is a continuation of International Application No. PCT/CN2021/143575 filed on Dec. 31, 2021, and entitled “CONTROL INFORMATION TRANSMISSION METHOD, APPARATUS, DEVICE, AND STORAGE MEDIUM”, the disclosure of which is incorporated herein by reference in its entirety.

### TECHNICAL FIELD

The disclosure relates to the field of communications, and more particularly to methods, apparatuses and devices for transmitting control information and a storage medium.

### BACKGROUND

In a New Radio (NR) system, a network device may configure different Downlink Control Information (DCI) formats for a terminal device to meet scheduling requirements of different scenarios and different network configurations. The network device may send a DCI message through a Physical Downlink Control Channel (PDCCH) channel, to schedule a service channel resource for the terminal device, such as a Physical Downlink Shared Channel (PDSCH) resource or a Physical Uplink Shared Channel (PUSCH) resource.

When the PDCCH channel is overloaded, idle service channel resources cannot be fully scheduled, resulting in the wastage of channel resources.

### SUMMARY

In a first aspect, a method for transmitting control information is provided, which is applied to a terminal device and includes the following operations.

Configuration information is acquired. The configuration information is used for configuring at least one available downlink control information format for the terminal device, and the at least one available downlink control information format includes a first downlink control information format for simultaneously scheduling multiple carriers.

Any of the at least one downlink control information format is monitored based on the configuration information.

In a second aspect, a method for transmitting control information is provided, which is applied to a network device and includes the following operations.

Downlink control information is sent to a terminal device. The downlink control information is sent based on configuration information for the terminal device, the configuration information is used for configuring at least one available downlink control information format for the terminal device, and the at least one available downlink control information format includes a first downlink control information format for simultaneously scheduling multiple carriers.

In a third aspect, an apparatus for transmitting control information is provided, which is applied to a terminal device and includes an acquisition module and a monitoring module.

The acquisition module is configured to acquire configuration information. The configuration information is used for configuring at least one available downlink control information format for the terminal device, and the at least one available downlink control information format includes a first downlink control information format for simultaneously scheduling multiple carriers.

The monitoring module is configured to monitor any of the at least one downlink control information format based on the configuration information.

In a fourth aspect, an apparatus for transmitting control information is provided, which is applied to a network device and includes a sending module.

The sending module is configured to send downlink control information to a terminal device. The downlink control information is sent based on configuration information for the terminal device, the configuration information is used for configuring at least one available downlink control information format for the terminal device, and the at least one available downlink control information format includes a first downlink control information format for simultaneously scheduling multiple carriers.

In a fifth aspect, a terminal device is provided, which includes a memory and a processor. The memory has stored therein a computer program, and the processor implements operations of the method in the first aspect when executing the computer program.

In a sixth aspect, a network device is provided, which includes a memory and a processor. The memory has stored therein a computer program, and the processor implements operations of the method in the second aspect when executing the computer program.

In a seventh aspect, a computer-readable storage medium is provided. The computer-readable storage medium has a computer program stored therein that, when executed by a processor, implements operations of the method in the first aspect or in the second aspect.

### BRIEF DESCRIPTION OF THE DRAWINGS

In order to more clearly illustrate the technical solution of the present disclosure or the related art, the drawings required in the descriptions of the embodiments or the related art are introduced briefly below. It will be apparent that the drawings in the following description are some embodiments of the disclosure, from which other drawings can be obtained without creative work by those of ordinary skill in the art.

FIG. 1 is a diagram of an application scenario for a method for transmitting control information according to an embodiment of the disclosure.

FIG. 2 is a flowchart illustrating a method for transmitting control information according to an embodiment of the disclosure.

FIG. 3 is a flowchart illustrating a method for transmitting control information according to an embodiment of the disclosure.

FIG. 4 is a flowchart illustrating a method for transmitting control information according to an embodiment of the disclosure.

FIG. 5 is a block diagram of an apparatus for transmitting control information according to an embodiment of the disclosure.

FIG. 6 is a block diagram of an apparatus for transmitting control information according to an embodiment of the disclosure.

FIG. 7 is a block diagram of an apparatus for transmitting control information according to an embodiment of the disclosure.

FIG. 8 is a block diagram of an apparatus for transmitting control information according to an embodiment of the disclosure.

FIG. 9 is a block diagram of an apparatus for transmitting control information according to an embodiment of the disclosure.

FIG. 10 is a block diagram of an apparatus for transmitting control information according to an embodiment of the disclosure.

FIG. 11 is a block diagram of an apparatus for transmitting control information according to an embodiment of the disclosure.

FIG. 12 is a schematic structural diagram of a network device according to an embodiment of the disclosure.

FIG. 13 is a schematic structural diagram of a terminal device according to an embodiment of the disclosure.

### DETAILED DESCRIPTION

In order to make objects, technical solutions and advantages of the disclosure clearer, the disclosure will be described below in detail in combination with the drawings and the embodiments. It should be understood that the specific embodiments described herein are used for illustrating the disclosure only and not intended to limit the disclosure.

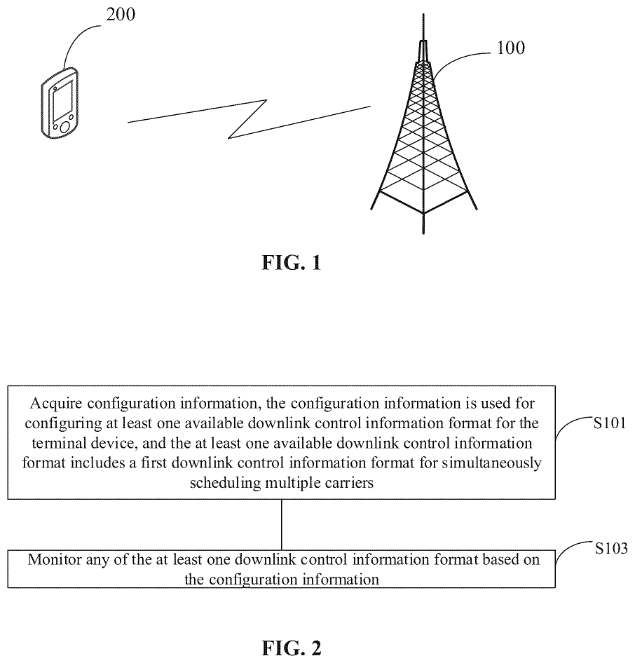

The methods for transmitting control information provided by the embodiments of the disclosure may be applied to the field of communication technologies. FIG. 1 is a diagram of an application scenario for a method for transmitting control information according to an embodiment of the disclosure. As illustrated in FIG. 1, the scenario includes a network device 100 and a terminal device 200 which communicate with each other through a network. The network device 100 may be a Base Transceiver Station (BTS) in Global System of Mobile communication (GSM) or in Code Division Multiple Access (CDMA). The network device 100 may also be a NodeB (NB) in Wideband Code Division Multiple Access (WCDMA). The network device 100 may further be an Evolutional Node B (eNB or eNodeB) in Long Term Evolution (LTE), a relay station, an access point, or a base station in a 5th-Generation (5G) network, and/or the like, which is not limited herein.

The terminal device 200 may be a wireless terminal which may be a device providing voice and/or other service data connectivity to a user, a handheld device with a wireless connection function, or other processing device connected to a wireless modem. The wireless terminal may communicate with one or more core networks via a Radio Access Network (RAN). The wireless terminal may be a mobile terminal such as a mobile phone (or referred to as a “cellular” phone), and the wireless terminal may be a computer with the mobile terminal, for example, may be a portable mobile device, a pocket-sized mobile device, a hand-held mobile device, a computer-built mobile device or vehicle-mounted mobile device, which exchange language and/or data with the RAN. The terminal device may be, for example, a Personal Communication Service (PCS) telephone, a cordless telephone, a Session Initiation Protocol (SIP) telephone, a Wireless Local Loop (WLL) station, a Personal Digital Assistant (PDA) or other devices.

The technical solutions in the disclosure will be described below in detail with specific embodiments. The following specific embodiments may be combined with each other, and some identical or similar concepts or processes may not be repeated in some embodiments.

Embodiments of the disclosure provides methods, apparatuses and devices for transmitting control information and a storage medium, which can improve the utilization rate of channel resources.

According to the above methods, apparatuses and devices for transmitting control information and a storage medium, the terminal device acquires the configuration information, and then monitors the downlink control information format based on the configuration information. The configuration information is used for configuring the available downlink control information format for the terminal device, and the available downlink control information format includes the first downlink control information format for simultaneously scheduling multiple carriers. Since the configuration information for the terminal device includes the first downlink control information format for simultaneously scheduling multiple carriers, the network device, in scheduling service channel resources for the terminal device, can send the downlink control information to the terminal device with the first downlink control information format, and simultaneously schedule resources on multiple carriers through the downlink control information, thereby improving the utilization rate of PDCCH resources for sending the downlink control information. In addition, it can avoid, wastage of resources caused by insufficient scheduling of the service channel resources when the PDCCH channel is overloaded, thereby improving the utilization rate of the service channel resources.

FIG. 2 is a flowchart illustrating a method for transmitting control information according to an embodiment of the disclosure. The method for transmitting control information in the embodiment is described by taking the terminal device running in FIG. 1 as an example. As illustrated in FIG. 2, the method for transmitting control information includes the following operations.

At block S101, configuration information is acquired. The configuration information is used for configuring at least one available downlink control information format for the terminal device, and the at least one available downlink control information format includes a first downlink control information format for simultaneously scheduling multiple carriers.

The configuration information is used for scheduling the at least one available downlink control information format of the terminal device. A network device may indicate positions of service channel resources to the terminal device through a PDCCH channel when scheduling the service channel resources for the terminal device. The information carried in the PDCCH channel is downlink control information, and a format of the downlink control information is one of the at least one available downlink control information format configured by the network device for the terminal device. The downlink control information may be used for scheduling PDSCH transmission, may also be used for scheduling PUSCH transmission, and may further indicate a modulation and coding scheme. The network device may select different downlink control information formats based on different scenario requirements, to send the downlink control information.

The configuration information may be contained in carrier configuration information configured by the network device for the terminal device. The carrier configuration information may include available carriers configured by the network device for the terminal device and respective parameters corresponding to the carriers. For each carrier, the configuration information includes at least one available downlink control information format corresponding to the carrier. For example, the available carriers configured by the network device for the terminal device are Carrier 1 and Carrier 2, and the configuration information includes at least one available downlink control information format corresponding to Carrier 1 and at least one available downlink control information format corresponding to Carrier 2. The available downlink control information formats corresponding to different carriers may be the same or different. The numbers of available downlink control information format(s) corresponding to different carriers may be the same or different. For example, the configuration information includes four available downlink control information formats corresponding to Carrier 1 and six available downlink control information formats corresponding to Carrier 2.

Each downlink control information format includes multiple information indication fields, and each of the information indication fields may include a format identifier, a transmission power control command for a scheduled channel, resource block allocation, frequency modulation resource allocation, an uplink index, a downlink index and/or the like. Downlink control information formats specified in the existing protocol may include DCI 0_0, DCI 1_0, DCI 0_1, DCI 1_1, DCI 0_2, DCI 1_2, DCI 2_0, DCI 2_1, DCI 2_2 and DCI 2_3, and each of the downlink control information formats may be used for scheduling service channel transmission in one carrier. The downlink control information formats specified in the existing protocol may further include DCI 2_0, DCI 2_1, DCI 2_2 and DCI 2_3, which are mainly used for the transmission of public information.

The available downlink control information format in the configuration information may include the existing format specified in the protocol, and may further include the first downlink control information format, which is different from the existing format. The first downlink control information format may be used for simultaneously scheduling multiple carriers, for example, the first downlink control information format may be used for simultaneously scheduling two carriers or three carriers.

In the first downlink control information format, a new information indication field may be added to indicate time-domain ranges and/or frequency-domain ranges of multiple carrier resources, or the resource indication manner in the existing downlink control information format may be adjusted to indicate the time-domain ranges or frequency-domain ranges of multiple carrier resources through the same information indication field, which is not limited here.

The configuration information may be information carried in a high-layer signaling from the network device to the terminal device, and the high-layer configuration signaling may be PDCCH-config. The network device may configure respective configuration information for each accessed terminal device and send the configuration information to the terminal device through the high-layer signaling. The terminal device may receive the configuration information sent by the network device after being registered to the network. During data transmission, when scheduling resources for the terminal device, the network device may select one available downlink control information format from the configuration information configured for the terminal device, and then send the downlink control information to the terminal device in the format.

After receiving the configuration information sent by the network device, the terminal device may store the configuration information at a preset storage location. During data transmission, the terminal device may retrieve the locally stored configuration information and receive the downlink control information based on the configuration information.

At block S103, any of the at least one downlink control information format is monitored based on the configuration information.

The terminal device may determine an available PDCCH resource for the terminal device based on PDCCH configuration parameter(s) configured by the network device. The PDCCH configuration resource may include a Common Control Resource Set (CORESET) of a PDCCH resource region and at least one search space. The CORESET may be a frequency-domain range and a time-domain range required by the PDCCH resource. The network device may configure different search spaces for the terminal device based on the service requirements, so that the terminal device may monitor any of the at least one downlink control information format in the search space.

The PDCCH configuration parameter(s) may include the frequency-domain resource and the number of continuous symbols of the PDCCH resource. The number of continuous symbols indicates the time-domain resource range of the PDCCH resource. The terminal device may monitor the downlink control information sent by the network device at corresponding symbol positions based on the PDCCH configuration parameter. The terminal device generally does not know the downlink control information format of the downlink control information being transmitted currently, and does not know the resource location of the downlink control information being sent to itself. The terminal device may verify the monitored downlink control information. If the verification is successful, the terminal device may determine that the monitored downlink control information is the downlink control information sent to itself by the network device, and then monitor the downlink control information format corresponding to the downlink control information, so as to determine the service channel resources based on the downlink control information format.

Sizes of different downlink control information formats may be the same or different. For example, one downlink control information format has a size of 100 bits and another downlink control information format has a size of 128 bits. When the terminal device monitors the downlink control information sent by the network device, the terminal device may perform blind detection based on the possible corresponding size of the downlink control information format.

The terminal device may determine the size of each downlink control information format based on the available downlink control information format(s) configured in the configuration information, and then determine the number of size(s) of the downlink control information format(s). The terminal device may determine the number of searches based on the number of size(s) of downlink control information format(s). For example, the number of sizes of the downlink control information formats corresponding to the terminal device is two, and the blind detection on each candidate PDCCH resource is performed for the two sizes.

It should be noted that the size of the first downlink control information format may be the same as or different from that of the existing downlink control information format, which is not limited herein.

After receiving the downlink control information sent by the network device, the terminal device may determine a resource for transmitting PDSCH and/or a resource for transmitting PUSCH scheduled by the network device on corresponding carriers based on the downlink control information. In some embodiments of the disclosure, the terminal device receives first downlink control information in the downlink control information, a format of the first downlink control information is the first downlink control information format, and the terminal device may determine, on multiple carriers, the resource for transmitting PDSCH and/or the resource for transmitting PUSCH based on the first downlink control information.

According to the above method for transmitting control information, the terminal device acquires the configuration information, and then monitors the downlink control information format based on the configuration information. The configuration information is used for configuring the available downlink control information format(s) for the terminal device, and the available downlink control information format(s) include(s) the first downlink control information format for simultaneously scheduling multiple carriers. Since the configuration information for the terminal device includes the first downlink control information format for simultaneously scheduling multiple carriers, the network device, when scheduling service channel resources for the terminal device, can send the downlink control information to the terminal device with the first downlink control information format, and simultaneously schedule resources on multiple carriers through the downlink control information, thereby improving the utilization rate of PDCCH resources for sending the downlink control information. In addition, it can avoid wastage of resources caused by insufficient scheduling of the service channel resources when the PDCCH channel is overloaded, thereby improving the utilization rate of the service channel resources.

In the configuration information, the downlink control information format capable of simultaneously scheduling multiple carriers may be configured for one carrier, or the downlink control information format capable of simultaneously scheduling multiple carriers may be configured for multiple carriers. In the following embodiments, the different configuration manners will be described respectively.

In an embodiment, the first downlink control information format is used for scheduling a first carrier set in a single scheduling, the first carrier set includes at least two carriers including a first carrier. The configuration information includes first configuration information, the first configuration information includes the available downlink control information format(s) corresponding to the first carrier, and the first configuration information may be used for configuring the first downlink control information format and configuring a resource occupied by the first downlink control information format.

The network device may schedule the resource for the terminal device through the first downlink control information, which corresponds to the first downlink control information format. When the first carrier is used as a scheduled carrier, the terminal device may receive the first downlink control information and determine the resource scheduled by the network device based on the first downlink control information.

The first downlink control information may be used for scheduling the first carrier, and may also be used for scheduling the first carrier and the second carrier, which is not limited herein. In some embodiments of the disclosure, the first downlink control information is used for scheduling the first carrier set in the single scheduling, the first carrier set includes at least two carriers including the first carrier.

The first carrier set may be configured by the network device for the terminal device or may be determined based on a protocol. For example, the first downlink control information is used for simultaneously scheduling the first carrier and the second carrier, the terminal device may determine, after receiving the first downlink control information, the resources in the first carrier and the second carrier based on the first downlink control information. That is, even if the first downlink control information format in the configuration information is not an available downlink control information format corresponding to the second carrier, the resource in the second carrier may be scheduled by the first downlink control information.

The first downlink control information format in the first configuration information may include a first uplink scheduling format and/or a first downlink scheduling format. The first uplink scheduling format is used for scheduling PUSCH transmission, and the first downlink scheduling format is used for scheduling PDSCH transmission. In some embodiments of the disclosure, the first downlink control information format includes first indication information for indicating that the first downlink control information format is used for uplink scheduling or downlink scheduling. The first downlink control information format may include a first information field, and the first information field may be used for carrying the first indication information. For example, the first indication information carried in an information field for distinguishing uplink scheduling or downlink scheduling in the first uplink scheduling format may be 0, and the first indication information carried in an information field for distinguishing uplink scheduling or downlink scheduling in the first downlink scheduling format may be 1.

In a configuration manner, the configuration information may include the first configuration information configured for the first carrier and second configuration information configured for a second carrier. The downlink control information format corresponding to the first carrier in the first configuration information may include {DCI 0_0, DCI 0_3, DCI 1_0, DCI 1_3}. The downlink control information format corresponding to the second carrier in the second configuration information may include {DCI 0_1, DCI 1_1}. The DCI 0_3 is the first uplink scheduling format, the DCI 1_3 is the first downlink scheduling format, and the DCI 0_3 and DCI 1_3 may be used for simultaneously scheduling the first carrier and the second carrier.

The network device may determine the first carrier for configuring the first downlink control information format based on the parameters of respective carriers in the first carrier set, so as to configure the first downlink control information format on the first carrier. The parameters of the respective carriers may be identifiers of the respective carriers in the first carrier set, frequency-domain bandwidths of the respective carriers, the numbers of downlink control information formats corresponding to the respective carriers, etc. The type of the carrier parameters is not limited here.

In some embodiments of the disclosure, the first carrier is a carrier with a minimum carrier indication value among the first carrier set.

In some embodiments of the disclosure, the first carrier is a carrier with maximum carrier indication value among the first carrier set.

The carrier indication value may be carrier identification information for uniquely identifying carriers supported by the terminal device.

In some embodiments of the disclosure, the first carrier is a carrier with a minimum frequency bandwidth among the first carrier set.

In some embodiments of the disclosure, the first carrier is a carrier with a maximum frequency bandwidth among the first carrier set.

The frequency bandwidth is a frequency range covered by the carrier. When the first carrier corresponds to a larger frequency-domain bandwidth, the number of bits required for an indication field indicating the frequency-domain resource range in the downlink information format corresponding to the first carrier is larger. The indication field with a larger number of bits can improve the flexibility of resource scheduling and schedule resources better on multiple carriers in the first carrier set.

In some embodiments of the disclosure, the first carrier is a carrier with the minimum number of sizes of downlink control information formats among the first carrier set.

When the number of sizes of downlink control information formats corresponding to the first carrier is the smallest among the carriers in the first carrier set, the first downlink control information format is configured on the first carrier, which can prevent the number of sizes of downlink control information formats corresponding to the first carrier from exceeding a preset threshold value.

The terminal device may support a search space set sharing function, such that the terminal device may monitor and receive the downlink control information for scheduling the second carrier in the search space configured for the first carrier.

According to the above method for transmitting control information, the first downlink control information format in the configuration information is the downlink control information format corresponding to the first carrier, which can reduce the number of bits of the configuration information and avoid the wastage of resources when configuring the information. Further, when the terminal device receives the downlink control information based on the configuration information, the terminal device may monitor the first downlink control information corresponding to the first downlink control information format in a case that the first carrier is the scheduled carrier, without the need of performing blind detection in a case that multiple carriers in the first carrier set are scheduled, thereby reducing the number and the complexity of monitoring the first downlink control information.

In an embodiment, the configuration information further includes second configuration information for configuring a second carrier. The second configuration information is used for configuring a second downlink control information format for scheduling the second carrier and configuring a resource occupied by the second downlink control information format. That is, each of the first carrier and the second carrier in the configuration information is configured with the downlink control information format capable of simultaneously scheduling multiple carriers. The first downlink control information format may be used for scheduling at least two carriers including the first carrier. The second downlink control information format may be used for scheduling at least two carriers including the second carrier. The at least two carriers including the first carrier may include the second carrier or may not include the second carrier. The at least two carriers including the second carrier may include the first carrier or may not include the first carrier. For example, the carriers supported by the terminal device may include the first carrier, the second carrier and a third carrier, the first downlink control information format corresponding to the first carrier may be used for scheduling the first carrier and the third carrier, and the second downlink control information format corresponding to the second carrier may be used for scheduling the first carrier and the second carrier. In some embodiments of the disclosure, each of the first downlink control information format and the second downlink control information format is used for simultaneously scheduling the first carrier and the second carrier.

The first downlink control information format may include a first uplink scheduling format and/or a first downlink scheduling format. The second downlink control information format may include a second uplink scheduling format and/or a second downlink scheduling format. The first uplink scheduling format and the second uplink scheduling format are used for scheduling PUSCH transmission of the first carrier and the second carrier; and the first downlink scheduling format and the second downlink scheduling format are used for scheduling PDSCH transmission of the first carrier and the second carrier.

In a configuration manner, the configuration information includes the first configuration information configured for the first carrier and the second configuration information configured for the second carrier. The downlink control information format corresponding to the first carrier in the first configuration information may include {DCI 0_0, DCI 0_3, DCI 1_0, DCI 1_3}, DCI 0_3 and DCI 1_3 are the first uplink scheduling format and the first downlink scheduling format in the first downlink control information format, respectively. The downlink control information format corresponding to the second carrier in the second configuration information may include {DCI 0_1, DCI 0_3, DCI 1_1, DCI 1_3}, DCI 0_3 and DCI 1_3 are the second uplink scheduling format and the second downlink scheduling format in the second downlink control information format, respectively. The DCI 0_3 may be used for simultaneously scheduling the PUSCH transmission of the first carrier and the second carrier, and the DCI 1_3 may be used for scheduling the PDSCH transmission in the first carrier and the second carrier.

When the first uplink scheduling format and the second uplink scheduling format are used for scheduling the PUSCH transmission of the first carrier and the second carrier, the first uplink scheduling format and the second uplink scheduling format may have a same number of bits, or have different numbers of bits.

When the first downlink scheduling format and the second downlink scheduling format are used for scheduling the PDSCH transmission of the first carrier and the second carrier, the first downlink scheduling format and the second downlink scheduling format have a same number of bits, or have different numbers of bits.

According to the above method for transmitting control information, multiple carriers in the configuration information for the terminal device are configured with the downlink control information format(s) capable of simultaneously scheduling multiple carriers, so that the network device can send the downlink control information to the terminal device with the downlink control information format in a case that multiple carriers are used as scheduled carriers, thereby increasing the transmission opportunity of the downlink control information corresponding to the downlink control information format(s) capable of simultaneously scheduling multiple carriers, and further improving the utilization rate of the PDCCH resources.

When the terminal device receives the downlink control information based on the configuration information, the number of size(s) of downlink control information format(s) in the configuration information is related to the number of searches for the downlink control information by the terminal device. For example, when the number of size(s) of the downlink control information format(s) corresponding to the terminal device is 4, the terminal device needs to search with the 4 sizes of the downlink control information formats respectively, which makes a high requirement on capability of the terminal device. Generally, each carrier can support a maximum of 4 sizes of the downlink control information formats. Each carrier can support that the number of sizes of downlink control information scrambled by Cell-Radio Network Temporary Identifier (C-RNTI) is less than or equal to 3.

In an embodiment, a number of downlink control information formats for scheduling PDSCH transmission corresponding to one carrier supported by the terminal device is less than or equal to 3; and/or a number of downlink control information formats for scheduling PUSCH transmission corresponding to one carrier supported by the terminal device is less than or equal to 3.

In an implementation, the downlink control information format that the network device can configure for the terminal device can include DCI 0_0, DCI 0_1, DCI 0_2, DCI 0_3, DCI 1_0, DCI 1_1, DCI 1_2, DCI 1_3. Herein, DCI 0_0, DCI 0_1, DCI 0_2 and DCI 0_3 are uplink scheduling formats, DCI 0_0, DCI 0_1 and DCI 0_2 are used for scheduling the first carrier, and DCI 0_3 is used for scheduling the first carrier and the second carrier. DCI 1_0, DCI 1_1, DCI 1_2 and DCI 1_3 are downlink scheduling formats, DCI 1_0, DCI 1_1 and DCI 1_2 are used for scheduling the first carrier, and DCI 1_3 is used for scheduling the first carrier and the second carrier. Considering the processing capability of the terminal device, i.e., the number of sizes of the downlink control information formats corresponding to each carrier does not exceed 3, at most 3 downlink control information formats for scheduling the PDSCH transmission and at most 3 downlink control information formats for scheduling the PUSCH transmission are configured for each carrier of the terminal device.

The combination of downlink control information formats that the network device can configure for each carrier of the terminal device can be one of the following combinations:
{DCI 0_0, DCI 1_0};
{DCI 0_1, DCI 1_1};
{DCI 0_0, DCI 0_3, DCI 1_0, DCI 1_3};
{DCI 0_1, DCI 0_3, DCI 1_1, DCI 1_3};
{DCI 0_0, DCI 0_1, DCI 0_3, DCI 1_0, DCI 1_1, DCI 1_3};
{DCI 0_0, DCI 0_2, DCI 0_3, DCI 1_0, DCI 1_2, DCI 1_3}.

According to the above method for transmitting control information, the number of the downlink control information formats of the carriers is limited in the configuration information for the terminal device, which can avoid the number of sizes of the downlink control information formats from exceeding the first threshold value as much as possible, thereby reducing the number of size alignment operations on the downlink control information formats

In an embodiment, in a case that a number of sizes of downlink control information formats corresponding to a third carrier determined based on the configuration information exceeds a first threshold value, the terminal device performs a size alignment operation on the downlink control information formats corresponding to the third carrier. Herein, the third carrier is one of carriers configured by a network device for the terminal device. For example, the third carrier may be the first carrier, the second carrier or other carriers supported by the terminal device. The first threshold value is related to the capability of the terminal device, which may be 3 or 4 and is not limited herein. The sizes of the aligned downlink control information formats is used for receiving the downlink control information, and the terminal device may monitor the downlink control information format through the aligned downlink control information formats. The limited number of sizes can reduce the number of searches for the downlink control information.

When performing the size alignment operation on the downlink control information format of the third carrier, the terminal device may perform the size alignment operation on one group of downlink control information formats for uplink scheduling and downlink scheduling in a same scenario. For example, one of the carriers is the first carrier, and the downlink control information formats corresponding to the first carrier include {DCI 0_0, DCI 0_3, DCI 1_0, DCI 1_3}. Herein, DCI 0_0 and DCI 1_0 are one group of downlink control information formats; DCI 0_3 and DCI 1_3 are another group of downlink control information formats. The terminal device may firstly perform the size alignment operation on one group of downlink control information formats, and when the number of sizes of the downlink control information formats corresponding to the first carrier still exceeds the first threshold value after the size alignment operation, then the terminal device performs the size alignment operation on the next group of downlink control information formats until the number of sizes of the downlink control information formats corresponding to the first carrier is equal to the first threshold value.

The terminal device may determine the alignment size of the downlink control information formats before performing the alignment operation on the downlink control information formats. The alignment size may be the size of the downlink scheduling formats in the two downlink control information formats or the size of the uplink scheduling formats in the two downlink control information formats, which is not limited herein. The alignment size may be a larger number of bits in the two downlink control information formats or a smaller number of bits in the two downlink control information formats, which is not limited herein.

The size alignment operation includes adding one or more padding bits to the downlink control information format or performing a truncation operation on the downlink control information format. The addition of padding bits may be zero-padding to the downlink control information format with a smaller size in the two aligned downlink control information formats, and the truncation operation may be deleting part of bits from the downlink control information format with a larger size in the two aligned downlink control information formats based on a preset rule, so that the numbers of bits in the two downlink control information formats are the same after the size alignment operation. For example, when performing the size alignment operation on DCI 0_0 and DCI 1_0, if the number of bits of DCI 0_0 is less than the number of bits of DCI 1_0, the zero-padding operation may be performed on DCI 0_0, so that the number of bits of DCI 0_0 after the zero-padding operation is equal to the number of bits of DCI 1_0. If the number of bits of DCI 0_0 is greater than the number of bits of DCI 1_0, the truncation operation may performed on DCI 0_0.

When performing the size alignment operation on each group of downlink control information formats in the downlink control information formats corresponding to the third carrier, one group of downlink control information formats may be randomly selected for performing the size alignment operation; or the size alignment operation may also be performed for each group of downlink control information formats based on a preset sequence.

In some embodiments of the disclosure, the third carrier may be the first carrier, and the first downlink control information format corresponding to the first carrier includes a first uplink scheduling format for scheduling PUSCH transmission and a first downlink scheduling format for scheduling PDSCH transmission. In an implementation, the process of performing the size alignment operation on the downlink control information formats corresponding to the first carrier may include that: the size alignment operation is performed on the first uplink scheduling format and the first downlink scheduling format; if a number of sizes of the downlink control information formats corresponding to the first carrier exceeds the first threshold value after the size alignment operation, a further size alignment operation is performed on other downlink control information formats corresponding to the first carrier.

For example, the downlink control information formats scrambled by C-RNTI corresponding to the first carrier of the terminal device may include {DCI 0_0, DCI 0_1, DCI 0_3, DCI 1_0, DCI 1_1, DCI 1_3}, and the number of sizes of the downlink control information formats corresponding to each carrier cannot exceed 3. The process of performing the size alignment operation on the downlink control information formats of the first carrier may include the following operations.

At a first operation, if the number of the sizes of the downlink control information formats corresponding to the first carrier is greater than 3, DCI 0_0 and DCI 1_0 are aligned, so that the number of bits of DCI 0_0 and the number of bits of DCI 1_0 are the same.

At a second operation, on the basis of the first operation, if the number of the sizes of the downlink control information formats corresponding to the first carrier is greater than 3, DCI 0_3 and DCI 1_3 are aligned, so that the number of bits of DCI 0_3 and the number of bits of DCI 1_3 are the same.

At a third operation, on the basis of the second operation, if the number of the sizes of the downlink control information formats corresponding to the first carrier is greater than 3, DCI 0_1 and DCI 1_1 are aligned, so that the number of bits of DCI 0_1 and the number of bits DCI 1_1 are the same.

Based on the above size alignment operations, in the downlink control information formats corresponding to the first carrier, the sizes of DCI 0_0, DCI 0_1 and DCI 0_3 may be different; the sizes of DCI 1_0, DCI 1_1 and DCI 1_3 may be different.

For another example, the downlink control information formats scrambled by C-RNTI corresponding to the first carrier of the terminal device may include {DCI 0_0, DCI 0_2, DCI 0_3, DCI 1_0, DCI 1_2, DCI 1_3}, and the number of sizes of the downlink control information formats corresponding to each carrier cannot exceed 3. The process of performing the size alignment operation on the downlink control information formats of the first carrier may include the following operations.

At a first operation, if the number of the sizes of the downlink control information formats corresponding to the first carrier is greater than 3, DCI 0_0 and DCI 1_0 are aligned, so that the number of bits of DCI 0_0 and the number of bits of DCI 1_0 are the same.

At a second operation, on the basis of the first operation, if the number of the sizes of the downlink control information formats corresponding to the first carrier is greater than 3, DCI 0_3 and DCI 1_3 are aligned, so that the number of bits of DCI 0_3 and the number of bits of DCI 1_3 are the same.

At a third operation, on the basis of the second operation, if the number of the sizes of the downlink control information formats corresponding to the first carrier is greater than 3, DCI 0_2 and DCI 1_2 are aligned, so that the number of bits of DCI 0_2 and the number of bits DCI 1_2 are the same.

Based on the above size alignment operations, in the downlink control information formats corresponding to the first carrier, the sizes of DCI 0_0, DCI 0_2 and DCI 0_3 may be different; the sizes of DCI 1_0, DCI 1_2 and DCI 1_3 may be different.

According to the above method for transmitting control information, the size alignment operation is performed on the first downlink control information format in the downlink control information formats corresponding to the first carrier finally, which can give a priority to ensuring data transmission when scheduling multiple carriers corresponding to the first downlink control information format.

In an implementation, the process of performing the size alignment operation on the downlink control information formats corresponding to the first carrier may include that: the size alignment operation is performed on other downlink control information formats corresponding to the first carrier than the first downlink control information format, if a number of sizes of the downlink control information formats corresponding to the first carrier exceeds the first threshold value after the size alignment operation, a further size alignment operation is performed on the first uplink scheduling format and the first downlink scheduling format.

For example, the downlink control information formats scrambled by C-RNTI corresponding to the first carrier of the terminal device may include {DCI 0_0, DCI 0_1, DCI 0_3, DCI 1_0, DCI 1_1, DCI 1_3}, and the number of sizes of the downlink control information formats corresponding to each carrier cannot exceed 3. The process of performing the size alignment operation on the downlink control information formats of the first carrier may include the following operations.

At a first operation, if the number of the sizes of the downlink control information formats corresponding to the first carrier is greater than 3, DCI 0_0 and DCI 1_0 are aligned, so that the number of bits of DCI 0_0 and the number of bits of DCI 1_0 are the same.

At a second operation, on the basis of the first operation, if the number of the sizes of the downlink control information formats corresponding to the first carrier is greater than 3, DCI 0_1 and DCI 1_1 are aligned, so that the number of bits of DCI 0_1 and the number of bits of DCI 1_1 are the same.

At a third operation, on the basis of the second operation, if the number of the sizes of the downlink control information formats corresponding to the first carrier is greater than 3, DCI 0_3 and DCI 1_3 are aligned, so that the number of bits of DCI 0_3 and the number of bits DCI 1_3 are the same.

Based on the above size alignment operations, in the downlink control information formats corresponding to the first carrier, the sizes of DCI 0_0, DCI 0_1 and DCI 0_3 may be different; the sizes of DCI 1_0, DCI 1_1 and DCI 1_3 may be different.

For another example, the downlink control information formats scrambled by C-RNTI corresponding to the first carrier of the terminal device may include {DCI 0_0, DCI 0_2, DCI 0_3, DCI 1_0, DCI 1_2, DCI 1_3}, and the number of sizes of the downlink control information formats corresponding to each carrier cannot exceed 3. The process of performing the size alignment operation on the downlink control information formats of the first carrier may include the following operations.

At a first operation, if the number of the sizes of the downlink control information formats corresponding to the first carrier is greater than 3, DCI 0_0 and DCI 1_0 are aligned, so that the number of bits of DCI 0_0 and the number of bits of DCI 1_0 are the same.

At a second operation, on the basis of the first operation, if the number of the sizes of the downlink control information formats corresponding to the first carrier is greater than 3, DCI 0_2 and DCI 1_2 are aligned, so that the number of bits of DCI 0_2 and the number of bits of DCI 1_2 are the same.

At a third operation, on the basis of the second operation, if the number of the sizes of the downlink control information formats corresponding to the first carrier is greater than 3, DCI 0_3 and DCI 1_3 are aligned, so that the number of bits of DCI 0_3 and the number of bits DCI 1_1 are the same.

Based on the above size alignment operations, in the downlink control information formats corresponding to the first carrier, the sizes of DCI 0_0, DCI 0_2 and DCI 0_3 may be different; the sizes of DCI 1_0, DCI 1_2 and DCI 1_3 may be different.

According to the above method for transmitting control information, the size alignment operation is performed on the first downlink control information format in the downlink control information formats corresponding to the first carrier preferentially, which can give a priority to ensuring data transmission when scheduling a single carrier.

It should be noted that the size alignment operation may be applied to the first carrier, and may also be applied to the second carrier.

In an embodiment, in the above configuration information, each of the first downlink control information format corresponding to the first carrier and the second downlink control information format corresponding to the second carrier is used for simultaneously scheduling the first carrier and the second carrier. The first downlink control information format includes the first uplink scheduling format and the first downlink scheduling format, and the second downlink control information format includes the second uplink scheduling format and the second downlink scheduling format. After the size alignment operations are performed on downlink control information formats corresponding to the first carrier and the second carrier respectively using the above methods, a size of the first uplink scheduling format is a first number of bits, a size of the first downlink scheduling format is a second number of bits, a size of the second uplink scheduling format is a third number of bits, and a size of the second downlink scheduling format is a fourth number of bits.

In some embodiments of the disclosure, the first number of bits is equal to the third number of bits, or the first number of bits is not equal to the third number of bits.

In some embodiments of the disclosure, the second number of bits is equal to the fourth number of bits, or the second number of bits is not equal to the fourth number of bits.

If the first number of bits is not equal to the third number of bits, the terminal device may perform a size alignment operation on the first uplink scheduling format and the second uplink scheduling format.

If the second number of bits is not equal to the fourth number of bits, the terminal device may perform a size alignment operation on the first downlink scheduling format and the second downlink scheduling format.

According to the above method for transmitting control information, after the size alignment operations are performed on downlink control information formats corresponding to the first carrier and the second carrier respectively, the terminal device further performs a size alignment operation on the first uplink scheduling format and the second uplink scheduling format, and further performs a size alignment operation on the first downlink scheduling format and the second downlink scheduling format, so that when the first carrier and the second carrier are used as the scheduled carriers, the sizes of the downlink control information corresponding to the first downlink control information format received by the terminal device are the same, thereby simplifying the operation of parsing the downlink control information by the terminal device.

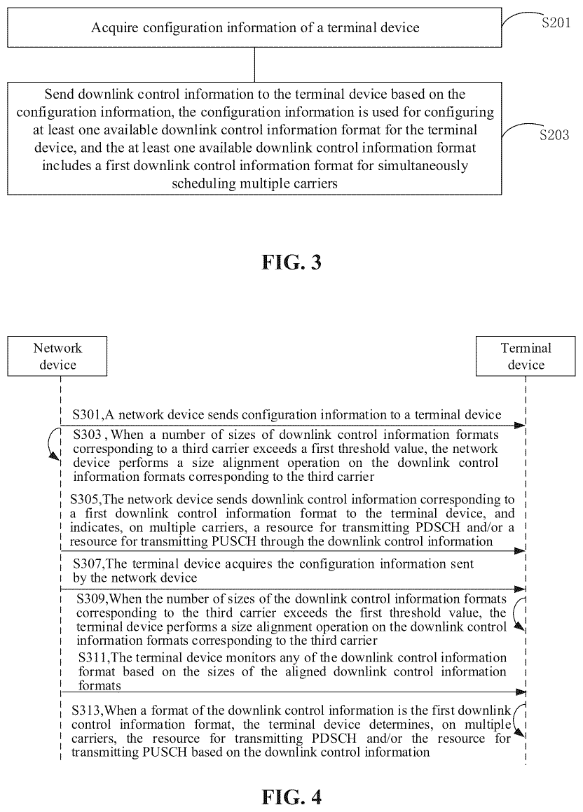

In an embodiment, a method for transmitting control information is provided, as illustrated in FIG. 3, the method includes the following operations.

At operation S201, configuration information for a terminal device is acquired.

At operation S203, downlink control information is sent to the terminal device based on the configuration information. The configuration information is used for configuring at least one available downlink control information format for the terminal device, and the at least one available downlink control information format includes a first downlink control information format for simultaneously scheduling multiple carriers.

According to the above method for transmitting control information, the network device determines the configuration information for the terminal device, and then sends the downlink control information to terminal device based on the configuration information. The configuration information is used for configuring available downlink control information format(s) for the terminal device, and the available downlink control information format(s) include(s) a first downlink control information format for simultaneously scheduling multiple carriers. Since the configuration information for the terminal device includes the first downlink control information format for simultaneously scheduling multiple carriers, the network device, when scheduling service channel resources for the terminal device, can send the downlink control information to the terminal device with the first downlink control information format, and simultaneously schedule resources on multiple carriers through the downlink control information, thereby improving the utilization rate of PDCCH resources for sending the downlink control information. In addition, it can avoid wastage of resources caused by insufficient scheduling for the service channel resources when the PDCCH channel is overloaded, thereby improving the utilization rate of the service channel resources.

In an embodiment, the first downlink control information format is used for scheduling a first carrier set in a single scheduling. The first carrier set includes at least two carriers including a first carrier. The configuration information includes first configuration information. The first configuration information is used for configuring the first downlink control information format and configuring a resource occupied by the first downlink control information format.

In an embodiment, the method further includes the following operation. The first carrier configured with the first downlink control information format is determined based on parameters of respective carriers in the first carrier set.

In an embodiment, the first carrier is a carrier with a minimum carrier indication value among the first carrier set; or the first carrier is a carrier with a maximum carrier indication value among the first carrier set.

In an embodiment, the first carrier is a carrier with a minimum frequency bandwidth among the first carrier set; or the first carrier is a carrier with a maximum frequency bandwidth among the first carrier set.

In an embodiment, the first carrier is a carrier with a minimum number of sizes of downlink control information formats among the first carrier set.

In an embodiment, in a cast that the terminal device supports a search space set sharing function, the network device sends the downlink control information to the terminal device.

In an embodiment, the first downlink control information format includes a first uplink scheduling format for scheduling PUSCH transmission and/or a first downlink scheduling format for scheduling PDSCH transmission.

In an embodiment, the configuration information further includes second configuration information. The second configuration information is used for configuring a second downlink control information format for scheduling a second carrier and configuring a resource occupied by the second downlink control information format.

In an embodiment, the second downlink control information format is used for scheduling at least two carriers including the second carrier.

In an embodiment, the first downlink control information format includes a first uplink scheduling format and/or a first downlink scheduling format, and the second downlink control information format includes a second uplink scheduling format and/or a second downlink scheduling format. The first uplink scheduling format and the second uplink scheduling format are used for scheduling PUSCH transmission, and the first downlink scheduling format and the second downlink scheduling format are used for scheduling PDSCH transmission.

In an embodiment, each of the first downlink control information format and the second downlink control information format is used for simultaneously scheduling the first carrier and the second carrier.

In an embodiment, the first uplink scheduling format and the second uplink scheduling format have a same number of bits; and/or the first downlink scheduling format and the second downlink scheduling format have a same number of bits.

In an embodiment, the first uplink scheduling format and the second uplink scheduling format have different numbers of bits; and/or the first downlink scheduling format and the second downlink scheduling format have different numbers of bits.

In an embodiment, if a number of sizes of downlink control information formats corresponding to a third carrier determined based on the configuration information exceeds a first threshold value, the network device performs a size alignment operation on the downlink control information formats corresponding to the third carrier. The third carrier is one of carriers configured by the network device for the terminal device.

In an embodiment, the size alignment operation includes adding one or more padding bits to the downlink control information format, or performing a truncation operation on the downlink control information format.

In an embodiment, the third carrier is the first carrier, and the first downlink control information format corresponding to the first carrier includes a first uplink scheduling format for scheduling PUSCH transmission and a first downlink scheduling format for scheduling PDSCH transmission. When performing the size alignment operation on the downlink control information formats corresponding to the first carrier, the network device performs the size alignment operation on the first uplink scheduling format and the first downlink scheduling format, and if a number of sizes of downlink control information formats corresponding to the first carrier exceeds the first threshold value after the size alignment operation, the network device performs a further size alignment operation on other downlink control information formats corresponding to the first carrier; alternatively, the network device performs a further size alignment operation on other downlink control information formats than the first downlink control information format, and if a number of sizes of downlink control information formats corresponding to the first carrier exceeds the first threshold value after the size alignment operation, the network device performs a further size alignment operation on the first uplink scheduling format and the first downlink scheduling format.

In an embodiment, each of the first downlink control information format and a second downlink control information format corresponding to a second carrier is used for simultaneously scheduling the first carrier and the second carrier. The first downlink control information format includes a first uplink scheduling format and a first downlink scheduling format; and the second downlink control information format includes a second uplink scheduling format and a second downlink scheduling format. After performing the size alignment operation on downlink control information formats corresponding to the first carrier and the second carrier, a size of the first uplink scheduling format is a first number of bits, a size of the first downlink scheduling format is a second number of bits, a size of the second uplink scheduling format is a third number of bits, and a size of the second downlink scheduling format is a fourth number of bits.

In an embodiment, the first number of bits is equal to the third number of bits; and/or the second number of bits is equal to the fourth number of bits.

In an embodiment, the first number of bits is not equal to the third number of bits.

In an embodiment, the network device may perform a size alignment operation on the first uplink scheduling format and the second uplink scheduling format.

In an embodiment, the second number of bits is not equal to the fourth number of bits.

In an embodiment, the network device may perform a size alignment operation on the first downlink scheduling format and the second downlink scheduling format.

In an embodiment, the first downlink control information format includes first indication information for indicating that the first downlink control information format is used for uplink scheduling or downlink scheduling.

In an embodiment, a number of downlink control information formats for scheduling PDSCH transmission corresponding to one carrier supported by the terminal device is less than or equal to 3; and/or a number of downlink control information formats for scheduling PUSCH transmission corresponding to one carrier supported by the terminal device is less than or equal to 3.

In an embodiment, the network device may indicate, on multiple carriers, a resource for transmitting PDSCH and/or a resource for transmitting PUSCH through first downlink control information. A format of the first downlink control information is the first downlink control information format.

For the implementation principle and technical effect of the above method for transmitting control information, the embodiments of the terminal device side can be referred to, which are not repeated here.

In an embodiment, based on the above embodiments, as illustrated in FIG. 4, a method for transmitting control information is provided, which includes the following operations.

At block S301, a network device sends configuration information to a terminal device.

At block S303, when a number of sizes of downlink control information formats corresponding to a third carrier exceeds a first threshold value, the network device performs a size alignment operation on the downlink control information formats corresponding to the third carrier.

At block S305, the network device sends downlink control information corresponding to a first downlink control information format to the terminal device, and indicates, on multiple carriers, a resource for transmitting PDSCH and/or a resource for transmitting PUSCH through the downlink control information.

At block S307, the terminal device acquires the configuration information sent by the network device.

At block S309, when the number of sizes of the downlink control information formats corresponding to the third carrier exceeds the first threshold value, the terminal device performs a size alignment operation on the downlink control information formats corresponding to the third carrier.

At block S311, the terminal device monitors any of the downlink control information formats based on the sizes of the aligned downlink control information formats.

At block S313, when a format of the downlink control information is the first downlink control information format, the terminal device determines, on multiple carriers, the resource for transmitting PDSCH and/or the resource for transmitting PUSCH based on the downlink control information.

For the implementation principle and technical effect of the above method for transmitting control information, the embodiments of the terminal device side can be referred to, which are not repeated here.

It should be understood that although the operations in the flowcharts in FIG. 2 to FIG. 4 are shown sequentially as indicated by arrows, these operations are not necessarily performed in the order indicated by the arrows. Unless explicitly stated in the disclosure, there is no strict sequence limitation on the execution of these operations, and these operations may be performed in other sequences. Furthermore, at least part of the operations in FIG. 2 to FIG. 4 may include multiple sub-operations or stages, which are not necessarily performed at the same time, but may be performed at different times. The sub-operations or stages are not necessarily performed in sequence, but may be performed in turn or alternately with at least part of other operations or sub-operation or stages of the other operations.

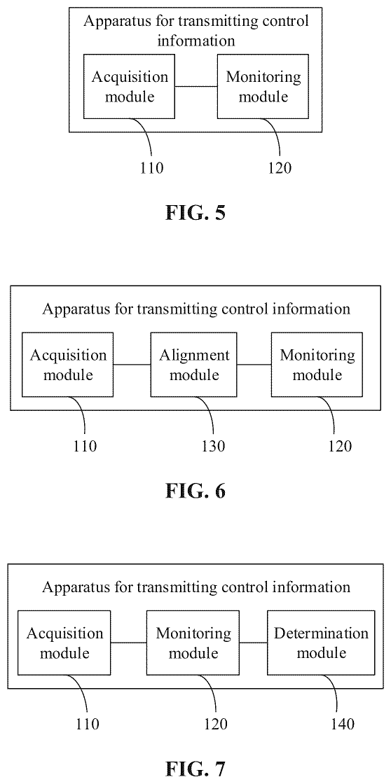

In an embodiment, an apparatus for transmitting control information is provided, as illustrated in FIG. 5, the apparatus includes an acquisition module 110 and a monitoring module 120.

An acquisition module 110 is configured to acquire configuration information. The configuration information is used for configuring at least one available downlink control information format for the terminal device, and the at least one available downlink control information format includes a first downlink control information format for simultaneously scheduling multiple carriers.

The monitoring module 120 is configured to monitor any of the at least one downlink control information format based on the configuration information.

In an embodiment, on the basis of the above embodiment, the configuration information includes first configuration information for configuring a first carrier, and the first configuration information is used for configuring a downlink control channel resource at which the downlink control information for scheduling the first carrier is located and configuring the downlink control information format corresponding to the downlink control information.

In an embodiment, on the basis of the above embodiments, the first downlink control information format is used for scheduling a first carrier set in a single scheduling. The first carrier set includes at least two carriers including a first carrier. The configuration information includes first configuration information. The first configuration information is used for configuring the first downlink control information format and configuring a resource occupied by the first downlink control information format.

In an embodiment, on the basis of the above embodiments, the first carrier is a carrier with a minimum frequency bandwidth among the first carrier set; or the first carrier is a carrier with a maximum frequency bandwidth among the first carrier set.

In an embodiment, on the basis of the above embodiments, the first carrier is a carrier with a minimum number of sizes of downlink control information formats among the first carrier set.

In an embodiment, on the basis of the above embodiments, the terminal device supports a search space set sharing function.

In an embodiment, on the basis of the above embodiments, the first downlink control information format includes a first uplink scheduling format for scheduling PUSCH transmission and/or a first downlink scheduling format for scheduling PDSCH transmission.

In an embodiment, on the basis of the above embodiments, the configuration information further includes second configuration information. The second configuration information is used for configuring a second downlink control information format for scheduling a second carrier and configuring a resource occupied by the second downlink control information format.

In an embodiment, on the basis of the above embodiments, the first downlink control information format includes a first uplink scheduling format and/or a first downlink scheduling format, and the second downlink control information format includes a second uplink scheduling format and/or a second downlink scheduling format. The first uplink scheduling format and the second uplink scheduling format are used for scheduling PUSCH transmission, and the first downlink scheduling format and the second downlink scheduling format are used for scheduling PDSCH transmission.

In an embodiment, on the basis of the above embodiments, the first downlink control information format includes a first uplink scheduling format and/or a first downlink scheduling format, and the second downlink control information format includes a second uplink scheduling format and/or a second downlink scheduling format. The first uplink scheduling format and the second uplink scheduling format are used for scheduling PUSCH transmission, and the first downlink scheduling format and the second downlink scheduling format are used for scheduling PDSCH transmission.

In an embodiment, on the basis of the above embodiments, each of the first downlink control information format and the second downlink control information format is used for simultaneously scheduling the first carrier and the second carrier.

In an embodiment, on the basis of the above embodiments, the first uplink scheduling format and the second uplink scheduling format have a same number of bits; and/or the first downlink scheduling format and the second downlink scheduling format have a same number of bits.

In an embodiment, on the basis of the above embodiments, the first uplink scheduling format and the second uplink scheduling format have different numbers of bits; and/or the first downlink scheduling format and the second downlink scheduling format have different numbers of bits.

In an embodiment, on the basis of the above embodiments, as illustrated in FIG. 6, the apparatus further includes an alignment module 130, which is configured to: if a number of sizes of downlink control information formats corresponding to a third carrier determined based on the configuration information exceeds a first threshold value, perform a size alignment operation on the downlink control information formats corresponding to the third carrier. The third carrier is one of carriers configured by the network device for the terminal device.

In an embodiment, on the basis of the above embodiments, the size alignment operation includes adding one or more padding bits to the downlink control information format, or performing a truncation operation on at least one of the downlink control information formats.

In an embodiment, on the basis of the above embodiments, the third carrier is the first carrier, and the first downlink control information format corresponding to the first carrier includes a first uplink scheduling format for scheduling PUSCH transmission and a first downlink scheduling format for scheduling PDSCH transmission. The alignment module 130 is specifically configured to: perform the size alignment operation on the first uplink scheduling format and the first downlink scheduling format; and if a number of sizes of the downlink control information formats corresponding to the first carrier exceeds the first threshold value after the size alignment operation, perform a further size alignment operation on other downlink control information formats corresponding to the first carrier.

In an embodiment, on the basis of the above embodiments, the third carrier is the first carrier, and the first downlink control information format corresponding to the first carrier includes a first uplink scheduling format for scheduling PUSCH transmission and a first downlink scheduling format for scheduling PDSCH transmission. The alignment module 130 is specifically configured to: perform the size alignment operation on other downlink control information format than the first downlink control information format; and if a number of sizes of the downlink control information formats corresponding to the first carrier exceeds the first threshold value after the size alignment operation, perform a further size alignment operation on the first uplink scheduling format and the first downlink scheduling format.

In an embodiment, on the basis of the above embodiments, each of the first downlink control information format and a second downlink control information format corresponding to a second carrier is used for simultaneously scheduling the first carrier and the second carrier. The first downlink control information format includes a first uplink scheduling format and a first downlink scheduling format; and the second downlink control information format includes a second uplink scheduling format and a second downlink scheduling format. After performing the size alignment operation on downlink control information formats corresponding to the first carrier and the second carrier, a size of the first uplink scheduling format is a first number of bits, a size of the first downlink scheduling format is a second number of bits, a size of the second uplink scheduling format is a third number of bits, and a size of the second downlink scheduling format is a fourth number of bits.

In an embodiment, on the basis of the above embodiments, the first number of bits is equal to the third number of bits; and/or the second number of bits is equal to the fourth number of bits.

In an embodiment, on the basis of the above embodiments, the first number of bits is not equal to the third number of bits.

In an embodiment, on the basis of the above embodiments, the alignment module 130 is further configured to perform a size alignment operation on the first uplink scheduling format and the second uplink scheduling format.

In an embodiment, on the basis of the above embodiments, the second number of bits is not equal to the fourth number of bits.

In an embodiment, on the basis of the above embodiments, the alignment module 130 is further configured to perform a size alignment operation on the first downlink scheduling format and the second downlink scheduling format.

In an embodiment, on the basis of the embodiments, the first downlink control information format includes first indication information for indicating that the first downlink control information format is used for uplink scheduling or downlink scheduling.

In an embodiment, on the basis of the above embodiments, a number of downlink control information formats for scheduling PDSCH transmission corresponding to one carrier supported by the terminal device is less than or equal to 3; and/or a number of downlink control information formats for scheduling PUSCH transmission corresponding to one carrier supported by the terminal device does is less than or equal to 3.

In an embodiment, on the basis of the above embodiments, as illustrated in FIG. 7, the apparatus further includes a determination module 140, the determination module 140 is configured to determine, on multiple carriers, a resource for transmitting PDSCH and/or a resource for transmitting PUSCH based on first downlink control information. A format corresponding to the first downlink control information is the first downlink control information format.

The implementation principle and technical effect of the apparatus for transmitting control information provided by the above embodiments are similar to those of the above method embodiments, which are not repeated here.

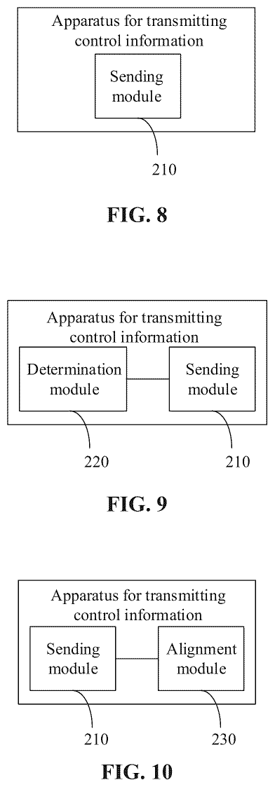

In an embodiment, an apparatus for transmitting control information is provided, as illustrated in FIG. 8, the apparatus includes sending module 210.

The sending module 210 is configured to send downlink control information to a terminal device. The downlink control information is sent based on configuration information for the terminal device, the configuration information is used for configuring at least one available downlink control information format for the terminal device, and the at least one available downlink control information format includes a first downlink control information format for simultaneously scheduling multiple carriers.

In an embodiment, on the basis of the above embodiment, the first downlink control information format is used for scheduling a first carrier set in a single scheduling. The first carrier set includes at least two carriers including a first carrier. The configuration information includes first configuration information. The first configuration information is used for configuring the first downlink control information format and configuring a resource occupied by the first downlink control information format.

In an embodiment, on the basis of the above embodiments, as illustrated in FIG. 9, the apparatus further includes a determination module 220. The determination module 220 is configured to determine the first carrier configured with the first downlink control information format based on parameters of respective carriers in the first carrier set.

In an embodiment, on the basis of the above embodiments, the first carrier is a carrier with a minimum carrier indication value among the first carrier set; or the first carrier is a carrier with a maximum carrier indication value among the first carrier set.

In an embodiment, on the basis of the above embodiments, the first carrier is a carrier with a minimum frequency bandwidth among the first carrier set; or the first carrier is a carrier with a maximum frequency bandwidth among the first carrier set.

In an embodiment, on the basis of the above embodiments, the first carrier is a carrier with a minimum number of sizes of downlink control information formats among the first carrier set.

In an embodiment, on the basis of the above embodiments, the sending module 210 is configured to send the downlink control information to the terminal device when the terminal device supports a search space set sharing function.

In an embodiment, on the basis of the above embodiments, the first downlink control information format includes a first uplink scheduling format for scheduling PUSCH transmission and/or a first downlink scheduling format for scheduling PDSCH transmission.

In an embodiment, on the basis of the above embodiments, the configuration information further includes second configuration information. The second configuration information is used for configuring a second downlink control information format for scheduling a second carrier and configuring a resource occupied by the second downlink control information format.

In an embodiment, on the basis of the above embodiments, the second downlink control information format is used for scheduling at least two carriers including the second carrier.

In an embodiment, on the basis of the above embodiments, the first downlink control information format includes a first uplink scheduling format and/or a first downlink scheduling format, and the second downlink control information format includes a second uplink scheduling format and/or a second downlink scheduling format. The first uplink scheduling format and the second uplink scheduling format are used for scheduling PUSCH transmission, and the first downlink scheduling format and the second downlink scheduling format are used for scheduling PDSCH transmission.

In an embodiment, on the basis of the above embodiments, each of the first downlink control information format and the second downlink control information format is used for simultaneously scheduling the first carrier and the second carrier.

In an embodiment, on the basis of the above embodiments, the first uplink scheduling format and the second uplink scheduling format have a same number of bits; and/or the first downlink scheduling format and the second downlink scheduling format have a same number of bits.

In an embodiment, on the basis of the above embodiments, the first uplink scheduling format and the second uplink scheduling format have different numbers of bits; and/or the first downlink scheduling format and the second downlink scheduling format have different numbers of bits.

In an embodiment, on the basis of the above embodiments, as illustrated in FIG. 10, the apparatus further includes an alignment module 230, which is configured to: if a number of sizes of downlink control information formats corresponding to a third carrier determined based on the configuration information exceeds a first threshold value, perform a size alignment operation on the downlink control information formats corresponding to the third carrier. The third carrier is one of carriers configured by the network device for the terminal device.

In an embodiment, on the basis of the above embodiments the size alignment operation includes adding one or more padding bits to at least one of the downlink control information formats, or performing a truncation operation on at least one of the downlink control information formats.

In an embodiment, on the basis of the above embodiments, the third carrier is the first carrier, and the first downlink control information format corresponding to the first carrier includes a first uplink scheduling format for scheduling PUSCH transmission and a first downlink scheduling format for scheduling PDSCH transmission. The alignment module 230 is configured to: perform the size alignment operation on the first uplink scheduling format and the first downlink scheduling format; and if a number of sizes of the downlink control information formats corresponding to the first carrier exceeds the first threshold value after the size alignment operation, perform a further size alignment operation on other downlink control information formats corresponding to the first carrier.

In an embodiment, on the basis of the above embodiments, the third carrier is the first carrier, and the first downlink control information format corresponding to the first carrier includes a first uplink scheduling format for scheduling PUSCH transmission and a first downlink scheduling format for scheduling PDSCH transmission. The alignment module 230 is configured to: perform the size alignment operation on other downlink control information formats than the first downlink control information format; and if a number of sizes of the downlink control information formats corresponding to the first carrier exceeds the first threshold value after the size alignment operation, perform a further size alignment operation on the first uplink scheduling format and the first downlink scheduling format.

In an embodiment, on the basis of the above embodiments, each of the first downlink control information format and a second downlink control information format corresponding to a second carrier is used for simultaneously scheduling the first carrier and the second carrier. The first downlink control information format includes a first uplink scheduling format and a first downlink scheduling format; and the second downlink control information format includes a second uplink scheduling format and a second downlink scheduling format. After performing the size alignment operation on downlink control information formats corresponding to the first carrier and the second carrier, a size of the first uplink scheduling format is a first number of bits, a size of the first downlink scheduling format is a second number of bits, a size of the second uplink scheduling format is a third number of bits, and a size of the second downlink scheduling format is a fourth number of bits.

In an embodiment, on the basis of the above embodiments, the first number of bits is equal to the third number of bits; and/or the second number of bits is equal to the fourth number of bits.

In an embodiment, on the basis of the above embodiments, the first number of bits is not equal to the third number of bits.

In an embodiment, on the basis of the above embodiments, the alignment module 230 is further configured to perform a size alignment operation on the first uplink scheduling format and the second uplink scheduling format.

In an embodiment, on the basis of the above embodiments, the second number of bits is not equal to the fourth number of bits.

In an embodiment, on the basis of the above embodiments, the alignment module 230 is further configured to perform a size alignment operation on the first downlink scheduling format and the second downlink scheduling format.

In an embodiment, on the basis of the above embodiments, the first downlink control information format includes first indication information for indicating that the first downlink control information format is used for uplink scheduling or downlink scheduling.

In an embodiment, on the basis of the above embodiments, a number of downlink control information formats for scheduling PDSCH transmission corresponding to one carrier supported by the terminal device is less than or equal to 3; and/or a number of downlink control information formats for scheduling PUSCH transmission corresponding to one carrier supported by the terminal device is less than or equal to 3.

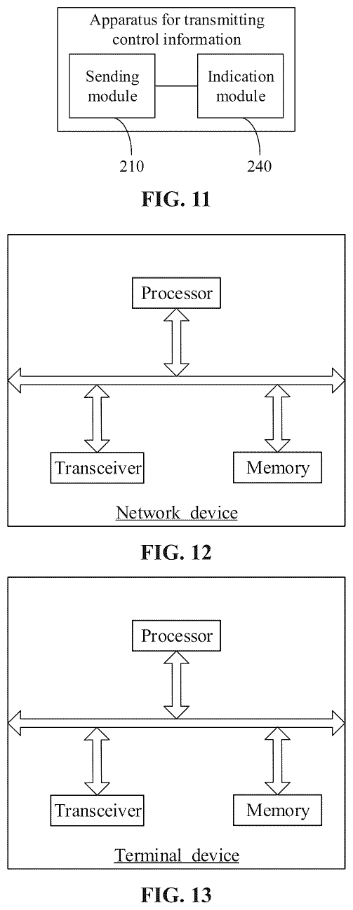

In an embodiment, on the basis of the above embodiments, as illustrated in FIG. 11, the apparatus further includes an indication module 240, the indication module 240 is configured to indicate, on multiple carriers, a resource for transmitting PDSCH and/or a resource for transmitting PUSCH through first downlink control information. A format corresponding to the first downlink control information is the first downlink control information format.

The implementation principle and technical effect of the apparatus for transmitting control information provided by the above embodiments are similar to those of the above method embodiments, which are not repeated here.

The division of modules in the apparatus for transmitting control information is only schematic description, and in other embodiments, the apparatus for transmitting control information may be divided into different modules as required to complete all or part of the functions of the apparatus for transmitting control information.

For the specific definition of the apparatus for transmitting control information, the definition of the method for transmitting control information described above may be referred to, which is not repeated here. Each module in the apparatus for transmitting control information may be fully or partially implemented by software, hardware or a combination of the software and the hardware. Each module can be embedded in or independent of the processor in a computer device in the form of the hardware, and can also be stored in a memory in the computer device in the form of the software to facilitate the processor to call and execute the operations corresponding to each module.

FIG. 12 is a schematic internal structural diagram of a network device according to an embodiment of the disclosure. As illustrated in FIG. 12, the network device includes a processor, a non-volatile storage medium, an internal memory, a transceiver and a network interface connected through a system bus. The processor is configured to provide computing and control capabilities and support the operation of the whole electronic device. The memory is configured to store data, programs and the like. The memory stores at least one computer program, which may be executed by the processor to implement the method for transmitting control information provided in the embodiments of the disclosure, which is applicable to the network device. The memory may include the non-volatile storage medium and the internal memory. The non-volatile storage medium stores an operating system and a computer program. The computer program may be executed by the processor to perform the method for transmitting control information provided by the various embodiments. The internal memory provides an environment for the operation of the operating system and the computer program in the non-volatile storage medium. The network interface may be an Ethernet card, a wireless network card or the like, which is configured to communicate with an external electronic device. Those skilled in the art will understand that the structure illustrated in FIG. 12 is only a block diagram of a portion of the structure related to the solution of the disclosure and does not constitute a limitation on the network device to which the solution of the disclosure is applied. The specific network device may include more or fewer components than that illustrated in the figure, or may combine certain components, or may have a different component arrangement.

In an embodiment, a terminal device is provided, an internal structural diagram of which may be illustrated in FIG. 13. The terminal device includes a processor, a memory, a transceiver, a network interface, a display screen and an input apparatus connected through a system bus. The processor of the computer device is configured to provide computing and control capabilities. The non-volatile storage medium stores an operating system and a computer program. The memory of the computer device includes a non-volatile storage medium and an internal memory. The internal memory provides an environment for the operation of the operating system and the computer program in the non-volatile storage medium. The network interface of the terminal device is configured to communicate with an external terminal through a network connection. The computer program is executed by the processor to perform the method for transmitting control information. The display screen of the terminal device may be a liquid crystal display screen or an electronic ink display screen. The input apparatus of the computer device may be a touch layer covered on the display screen, a key, a trackball or a touchpad arranged on the housing of the terminal device, or may be a button, a trackball or a touchpad set on a shell of the computer device; or may be an external keyboard, a touchpad or a mouse, etc.

Those skilled in the art will understand that the structure illustrated in FIG. 12 or FIG. 13 is only a block diagram of a portion of the structure related to the solution of the disclosure and does not constitute a limitation on the network device or terminal to which the solution of the disclosure is applied. The specific network device or terminal may include more or fewer components than that illustrated in the figure, or may combine certain components, or may have a different component arrangement.

Each module in the apparatuses for transmitting control information provided in the embodiments of the disclosure may be implemented in the form of a computer program. The computer program may be run on a terminal device or a network device. The program module composed of the computer program may be stored on a memory of the terminal device or the network device. The computer program, when executed by a processor, causes the processor to perform the operations of the methods described in the embodiments of the disclosure.

In an embodiment, a network device is provided, which includes a memory and a processor. The memory has stored thereon a computer program, and the processor implements operations of the method for transmitting control information described above when executing the computer program.

The implementation principle and technical effect of the network device provided by the above embodiment are similar to those of the above method embodiments, which are not repeated here.

In an embodiment, a terminal device is provided, which includes a memory and a processor. The memory has stored thereon a computer program, and the processor implements operations of the method for transmitting control information described above when executing the computer program.

The implementation principle and technical effect of the terminal device provided by the above embodiment are similar to those of the above method embodiments, which are not repeated here.

An embodiment of the disclosure further provides a computer-readable storage medium, which is a non-volatile computer-readable storage medium. The non-volatile computer-readable storage medium contains one or more computer-executable instructions that, when executed by one or more processors, cause the one or more processors to perform operations of the methods for transmitting control information described above.

The implementation principle and technical effect of the computer-readable storage medium the above embodiment are similar to those of the above method embodiments, which are not repeated here.

A computer program product includes instructions that, when run on a computer, cause the computer to perform the methods for transmitting control information.

Any reference to the memory, storage, database or other medium used herein may include non-volatile and/or volatile memories. The non-volatile memory may include a Read-Only Memory (ROM), a Programmable ROM (PROM), an Electrically Programmable ROM (EPROM), Electrically Erasable PROM (EEPROM) or a flash memory. The volatile memory may include a Random Access Memory (RAM) and is used as an external high-speed cache. In an exemplary and non-limiting example, RAMs may be in various forms, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), a Direct Rambus RAM (DRRAM), a Direct Rambus Dynamic RAM (DRDRAM) and a Rambus Dynamic RAM (RDRAM).

The above embodiments are merely several implementations of the disclosure with specific and detailed description, but cannot be understood as a limitation the scope of the disclosure. It should be noted that any variation or replacement by those of ordinary skill in the art without departing from the concept of the disclosure shall fall within the scope of the disclosure. Therefore, the scope of the disclosure shall be subjected to the scope of attached claims.

1. A method for transmitting control information, applied to a terminal device, the method comprising:
acquiring configuration information, wherein the configuration information is used for configuring at least one available downlink control information format for the terminal device, and the at least one available downlink control information format comprises a first downlink control information format for simultaneously scheduling a plurality of carriers; and
monitoring any of the at least one downlink control information format based on the configuration information.

2. The method of claim 1, wherein
the first downlink control information format is used for scheduling a first carrier set in a single scheduling, wherein the first carrier set comprises at least two carriers comprising a first carrier;
the configuration information comprises first configuration information, wherein the first configuration information is used for configuring the first downlink control information format and configuring a resource occupied by the first downlink control information format; and
the first downlink control information format comprises a first uplink scheduling format for scheduling Physical Uplink Shared Channel (PUSCH) transmission and/or a first downlink scheduling format for scheduling Physical Downlink Shared Channel (PDSCH) transmission.

3. The method of claim 2, further comprising:
if a number of sizes of downlink control information formats corresponding to a third carrier determined based on the configuration information exceeds a first threshold value, performing a size alignment operation on the downlink control information formats corresponding to the third carrier, the third carrier being one of carriers configured by a network device for the terminal device.

4. The method of claim 3, wherein the size alignment operation comprises:
adding one or more padding bits to at least one of the downlink control information formats, or
performing a truncation operation on at least one of the downlink control information formats.

5. The method of claim 3, wherein
the third carrier is the first carrier, and the first downlink control information format corresponding to the first carrier comprises a first uplink scheduling format for scheduling Physical Uplink Shared Channel (PUSCH) transmission and a first downlink scheduling format for scheduling Physical Downlink Shared Channel (PDSCH) transmission,
wherein performing the size alignment operation on the downlink control information formats corresponding to the third carrier comprises:
performing the size alignment operation on the first uplink scheduling format and the first downlink scheduling format; and
if a number of sizes of the downlink control information formats corresponding to the first carrier exceeds the first threshold value after the size alignment operation, performing a further size alignment operation on other downlink control information formats corresponding to the first carrier.

6. The method of claim 3, wherein
the third carrier is the first carrier, and the first downlink control information format corresponding to the first carrier comprises a first uplink scheduling format for scheduling Physical Uplink Shared Channel (PUSCH) transmission and a first downlink scheduling format for scheduling Physical Downlink Shared Channel (PDSCH) transmission,
wherein performing the size alignment operation on the downlink control information formats corresponding to the third carrier comprises:
performing a size alignment operation on other downlink control information formats than the first downlink control information format; and if a number of sizes of the downlink control information formats corresponding to the first carrier exceeds the first threshold value after the size alignment operation, performing a further size alignment operation on the first uplink scheduling format and the first downlink scheduling format.

7. The method of claim 1, wherein the first downlink control information format comprises first indication information for indicating that the first downlink control information format is used for uplink scheduling or downlink scheduling.

8. The method of claim 2, wherein
a number of downlink control information formats for scheduling Physical Downlink Shared Channel (PDSCH) transmission corresponding to one carrier supported by the terminal device is less than or equal to 3; and/or
a number of downlink control information formats for scheduling Physical Uplink Shared Channel (PUSCH) transmission corresponding to one carrier supported by the terminal device is less than or equal to 3,
wherein the method further comprises: determining, on the plurality of carriers, a resource for transmitting Physical Downlink Shared Channel (PDSCH) and/or a resource for transmitting Physical Uplink Shared Channel (PUSCH) based on first downlink control information, wherein a format corresponding to the first downlink control information is the first downlink control information format.

9. A network device, comprising: a memory and a processor, wherein the memory has stored therein a computer program, and the processor, when executing the computer program, is configured to:
send downlink control information to a terminal device, wherein the downlink control information is sent based on configuration information for the terminal device, the configuration information is used for configuring at least one available downlink control information format for the terminal device, and the at least one available downlink control information format comprises a first downlink control information format for simultaneously scheduling a plurality of carriers.

10. The network device of claim 9, wherein
the first downlink control information format is used for scheduling a first carrier set in a single scheduling, wherein the first carrier set comprises at least two carriers comprising a first carrier;
the configuration information comprises first configuration information, wherein the first configuration information is used for configuring the first downlink control information format and configuring a resource occupied by the first downlink control information format; and
the first downlink control information format comprises a first uplink scheduling format for scheduling Physical Uplink Shared Channel (PUSCH) transmission and/or a first downlink scheduling format for scheduling Physical Downlink Shared Channel (PDSCH) transmission.

11. The network device of claim 9, wherein the processor is further configured to:
if a number of sizes of downlink control information formats corresponding to a third carrier determined based on the configuration information exceeds a first threshold value, perform a size alignment operation on the downlink control information formats corresponding to the third carrier, the third carrier being one of carriers configured by the network device for the terminal device.

12. The network device of claim 11, wherein the size alignment operation comprises:
adding one or more padding bits to at least one of the downlink control information formats, or
performing a truncation operation on at least one of the downlink control information formats.

13. The network device of claim 11, wherein
the third carrier is the first carrier, and the first downlink control information format corresponding to the first carrier comprises a first uplink scheduling format for scheduling Physical Uplink Shared Channel (PUSCH) transmission and a first downlink scheduling format for scheduling Physical Downlink Shared Channel (PDSCH) transmission,
wherein in performing the size alignment operation on the downlink control information formats corresponding to the third carrier, the processor is configured to:
perform the size alignment operation on the first uplink scheduling format and the first downlink scheduling format; and
if a number of sizes of downlink control information formats corresponding to the first carrier exceeds the first threshold value after the size alignment operation, perform a further size alignment operation on other downlink control information formats corresponding to the first carrier.

14. The network device of claim 11, wherein
the third carrier is the first carrier, and the first downlink control information format corresponding to the first carrier comprises a first uplink scheduling format for scheduling Physical Uplink Shared Channel (PUSCH) transmission and a first downlink scheduling format for scheduling Physical Downlink Shared Channel (PDSCH) transmission,
wherein in performing the size alignment operation on the downlink control information formats corresponding to the third carrier, the processor is configured to:
perform the size alignment operation on other downlink control information formats than the first downlink control information format;
if a number of sizes of downlink control information formats corresponding to the first carrier exceeds the first threshold value after the size alignment operation, perform a further size alignment operation on the first uplink scheduling format and the first downlink scheduling format.

15. The network device of claim 9, wherein the first downlink control information format comprises first indication information for indicating that the first downlink control information format is used for uplink scheduling or downlink scheduling.

16. The network device of claim 9, wherein
a number of downlink control information formats for scheduling Physical Downlink Shared Channel (PDSCH) transmission corresponding to one carrier supported by the terminal device is less than or equal to 3; and/or
a number of downlink control information formats for scheduling Physical Uplink Shared Channel (PUSCH) transmission corresponding to one carrier supported by the terminal device does is less than or equal to 3,
wherein the processor is further configured to: indicate, on the plurality of carriers, a resource for transmitting Physical Downlink Shared Channel (PDSCH) and/or a resource for transmitting Physical Uplink Shared Channel (PUSCH) through first downlink control information, wherein a format corresponding to the first downlink control information is the first downlink control information format.

17. A terminal device, comprising a memory and a processor, wherein the memory has stored therein a computer program, and the processor, when executing the computer program, is configured to:
acquire configuration information, wherein the configuration information is used for configuring at least one available downlink control information format for the terminal device, and the at least one available downlink control information format comprises a first downlink control information format for simultaneously scheduling a plurality of carriers; and
monitor any of the at least one downlink control information format based on the configuration information.

18. The terminal device of claim 17, wherein
the first downlink control information format is used for scheduling a first carrier set in a single scheduling, wherein the first carrier set comprises at least two carriers comprising a first carrier;
the configuration information comprises first configuration information, wherein the first configuration information is used for configuring the first downlink control information format and configuring a resource occupied by the first downlink control information format; and
the first downlink control information format comprises a first uplink scheduling format for scheduling Physical Uplink Shared Channel (PUSCH) transmission and/or a first downlink scheduling format for scheduling Physical Downlink Shared Channel (PDSCH) transmission.

19. The terminal device of claim 18, wherein the processor is further configured to:
if a number of sizes of downlink control information formats corresponding to a third carrier determined based on the configuration information exceeds a first threshold value, perform a size alignment operation on the downlink control information formats corresponding to the third carrier, the third carrier being one of carriers configured by a network device for the terminal device,
wherein the size alignment operation comprises:
adding one or more padding bits to at least one of the downlink control information formats, or
performing a truncation operation on at least one of the downlink control information formats.

20. The terminal device of claim 18, wherein
the third carrier is the first carrier, and the first downlink control information format corresponding to the first carrier comprises a first uplink scheduling format for scheduling Physical Uplink Shared Channel (PUSCH) transmission and a first downlink scheduling format for scheduling Physical Downlink Shared Channel (PDSCH) transmission,
wherein in performing the size alignment operation on the downlink control information formats corresponding to the third carrier, the processor is configured to:
perform the size alignment operation on the first uplink scheduling format and the first downlink scheduling format, and
if a number of sizes of the downlink control information formats corresponding to the first carrier exceeds the first threshold value after the size alignment operation, perform a further size alignment operation on other downlink control information formats corresponding to the first carrier,
wherein the third carrier is the first carrier, and the first downlink control information format corresponding to the first carrier comprises a first uplink scheduling format for scheduling Physical Uplink Shared Channel (PUSCH) transmission and a first downlink scheduling format for scheduling Physical Downlink Shared Channel (PDSCH) transmission,
wherein in performing the size alignment operation on the downlink control information formats corresponding to the third carrier, the processor is configured to:
perform a size alignment operation on other downlink control information formats than the first downlink control information format, and
if a number of sizes of the downlink control information formats corresponding to the first carrier exceeds the first threshold value after the size alignment operation, perform a further size alignment operation on the first uplink scheduling format and the first downlink scheduling format.
